(19) United States
(12) Patent Application Publication
(10) Pub. No.: US 2011/0238500 A1
(43) Pub. Date: Sep. 29, 2011

(54) SYSTEM AND METHOD FOR EXPOSING ADVERTISEMENT BASED ON KEYWORD IN REAL TIME

(75) Inventor: Kyung-Hoon KIM, Seongnam-si (KR)

(73) Assignee: NHN BUSINESS PLATFORM CORPORATION, Seongnam-si (KR)

(21) Appl. No.: 13/074,372

(22) Filed: Mar. 29, 2011

(30) Foreign Application Priority Data
Mar. 29, 2010 (KR) 10-2010-0028130

(51) Int. Cl. G06Q 30/00

(52) U.S. Cl. 705/14.54; 705/14.49

(57) ABSTRACT

Provided are a system and a method for exposing an advertisement based on a keyword in real time. The system may include an inventory determining unit to determine an inventory for each target keyword using a search log based on a keyword of a user, and an advertisement registering unit to register an advertisement into an inventory corresponding to a target keyword selected by an advertiser. The system may expose an advertisement while precisely reflecting a subject of interest of the user, thereby improving an advertising effect.

### CROSS-REFERENCE TO RELATED APPLICATION

This application claims priority to and the benefit of Korean Patent Application No. 10-2010-0028130, filed on Mar. 29, 2010, which is hereby incorporated by reference for all purposes as if fully set forth herein.

### BACKGROUND OF THE INVENTION

1. Field of the Invention

Exemplary embodiments of the present invention relate to a system and a method for exposing an advertisement in relation to search, and more particularly, to a system and method for obtaining user identity information and keyword information inputted by the user to respond a request for an advertisement related to the user identity information.

2. Discussion of the Related Art

Users may obtain request information by inputting a keyword in a search engine. The requested information may often reflect subjects of interest of the users. The subjects of interest of the users may become a main source of information utilized for achieving the effects of advertisements of advertisers.

When a user visits a predetermined site and the site proposes an advertisement related to a content in which the user is interested, an advertising effect may be maximized. Accordingly, there is a need for an approach to determine an advertisement and a content in which a user is interested. Also, there is a need to provide a subject of interest of a user as an objective index to promote advertisement registration of an advertiser.

### SUMMARY OF THE INVENTION

Exemplary embodiments of the present invention provide an apparatus, system, method and software for providing an advertisement, related to a subject of interest of a user, based on a keyword inputted by the user, thereby maximizing an advertising effect.

Exemplary embodiments of the present invention also provide an apparatus, system, method and software for providing an advertisement matched to the most recently inputted keyword, among keywords inputted by a user, thereby precisely reflecting a subject of interest of a user at the time of visiting a service page of a publisher.

Exemplary embodiments of the present invention also provide an apparatus, system, method and software for providing an advertiser with objective information related to subjects of interest of users so that the advertiser may determine information about a marketable advertisement inventory to register an advertisement using search logs based on the subjects of interests of users associated with search activities of the users.

Additional features of the invention will be set forth in the description which follows, and in part will be apparent from the description, or may be learned by practice of the invention.

Exemplary embodiments of the present invention disclose a system to expose an advertisement based on a keyword in real time. The system includes an advertisement matching unit to extract an advertisement matched to a keyword inputted by a user and to generate a matching table configured to store the extracted advertisement in relation to identity information of the user, an advertisement registering unit configured to register an advertisement of an advertiser by providing a marketable inventory, and an advertisement providing unit configured to provide a publisher with an advertisement included in the matching table based on the identity information of the user who visited a service page of the publisher.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIGS. 1 and 2 are system diagrams to expose an advertisement based on a keyword, in real time, according to exemplary embodiments of the present invention.

FIG. 3 is a diagram illustrating an example of a keyword to determine a subject of interest of a user according to exemplary embodiments of the present invention.

FIG. 4 is a diagram illustrating an example of an advertisement unit set by an advertiser according to exemplary embodiments of the present invention.

FIG. 5 is a diagram illustrating an example of user profile setting according to exemplary embodiments of the present invention.

FIG. 6 is a diagram illustrating an example of impressions provided for an inventory of a keyword according to exemplary embodiments of the present invention.

FIG. 7 is a diagram illustrating an example of guarantees added to a plurality of keywords according to exemplary embodiments of the present invention.

FIG. 8 is a diagram illustrating an example of a keyword share sorted for each class of a target keyword according to exemplary embodiments of the present invention.

FIG. 9 is a flowchart illustrating a process for generating a matching table according to exemplary embodiments of the present invention.

FIG. 10 is a flowchart illustrating a process for providing an advertisement based on identity information of a user according to exemplary embodiments of the present invention.

FIG. 11 illustrates an exemplary computing hardware (e.g., computer system) upon which an embodiment according to the invention can be implemented.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity Like reference numerals in the drawings denote like elements.

It will be understood that when an element is referred to as being “connected to” or “coupled to” another element, it can be directly connected to the other element, or intervening elements may be present.

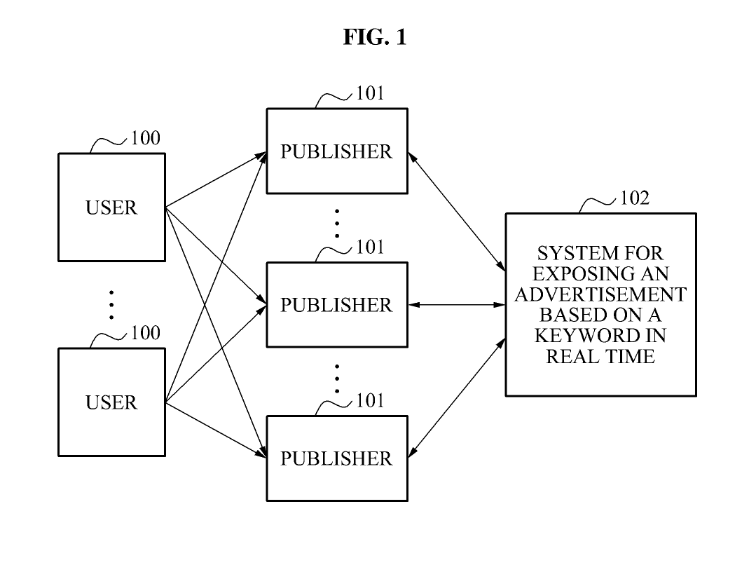

FIG. 1 is a diagram illustrating a structure of a system 120 for providing an advertisement based on a keyword, in real time, according to exemplary embodiments of the present invention.

Referring to FIG. 1, a user 100 may conduct a search by inputting a keyword in a publisher 101. In this example, the publisher 101 may be a search engine that may provide the user 100 with a search result related to the keyword, or a subject that may display a service page to the user 100.

The system 102 for providing an advertisement based on a keyword in real time may collect a keyword inputted by the user 100 through the publisher 101, and may extract an advertisement matched to the keyword among pre-registered advertisements of an advertiser. In this example, the publisher 101 may be a plurality of publishers, and the system 102 may collect a keyword from the publisher 101 managed by the system 102 or the publisher 101 operated by another subject.

The system 102 may then generate a matching table by correlating the extracted advertisement to identity information of the user 100. For example, the matching table may store the identity information of the user of the keyword corresponding to the advertisement. In this example, the identity information of the user may include cookie information. Alternatively, the identity information of the user may include an identification (ID) of the user. By way of example, a description will be hereinafter made based on cookie information.

For example, the matching table may also store valid date information. For example, the user 100 may determine valid date information based on a number of elapsed dates from a keyword input time, and may store the valid date information in the matching table. Whenever the user 100 inputs a keyword, the system 102 may update the matching table when there is an advertisement matched to the keyword.

When the user 100 visits a service page of the publisher 101, the system 102 may extract an advertisement from the matching table based on the correlated identity information of the user 100. Also, the system 102 may provide the extracted advertisement to the publisher 101 of the service page visited by the user 100.

According to exemplary embodiments of the present invention, because the matching table is continuously updated, a plurality of advertisements may be included in the matching table. The system 102 may provide the publisher 101 with an advertisement matched to a keyword inputted the most recently, from the time of visiting the service page of the publisher 101, among keywords inputted by the user 100.

Alternatively, the system 102 may provide the publisher 101 with an advertisement matched to a keyword inputted for a predetermined time in the past, from the time of visiting the service page of the publisher 101, among keywords inputted by the user 100. The publisher 101 may roll up and expose the advertisement provided from the system 102 at random basis through the service page.

According to exemplary embodiments of the present invention, because a subject of interest of the user 100 is recorded in the matching table, related advertisements corresponding to the subject of interest of the user may be exposed through any publisher 101 visited by the user 100. However, when different users 100 visit the publisher 101, different advertisements may be exposed to each user 100.

Also, although the user 100 makes a search by inputting a keyword only in the publisher X 101, an advertisement matched to the identity information of the user 100 that is stored in the matching table may be exposed through the publisher Y 101 when the user 100 visits the publisher Y 101.

Also, when the identity information of the user 100 is a cookie, the publisher 101 may vary exposure of an advertisement, depending on a terminal used by the user 100. For example, when the user 100 inputs a keyword related to an animal in a computer X at home and inputs a keyword related to a real estate in a computer Y at the office, different advertisements may be exposed when the user 100 visits a service page of the publisher 101 through the computer X and when the user 100 visits a service page of the publisher 101 through the computer Y.

Also, when the identity information of the user 100 is a login ID of the user 100, the same advertisement may be exposed regardless of a terminal used by the user 100. For example, when the user 100 inputs a keyword related to an animal in a computer X at home and inputs a keyword related to a real estate in a computer Y at the office, the same advertisement may be exposed, regardless of the computer used, if the user 100 logged in with the same ID. However, if the user 100 logged in with different IDs, different advertisements may be exposed depending on the login IDs.

When information not for directly identifying a user, such as a cookie, is used as identity information of the user, the identity information may vary depending on a terminal of the user. In this example, two terminals used by the same user may be managed using different identity information. As described above, different identity information for each terminal may belong to the same user, based on information for directly identifying the user, that is, login ID information. In this example, both the login ID information and the identity information for each terminal may be used to provide an advertisement.

Before the system 102 generates a matching table, the system 102 may receive registration of an advertisement from an advertiser. For example, the system 102 may provide a number of marketable advertisement inventories for a keyword inputted by the user 100. The system 102 may calculate information about an advertisement product sold to an advertiser, based on a usage log in a publisher, accessed by the user. For example, the system 102 may calculate information about an estimated impression of a Cost-Per-Mille (CPM)-based charging model, and may provide information about the estimated value to an advertiser that purchases an advertisement.

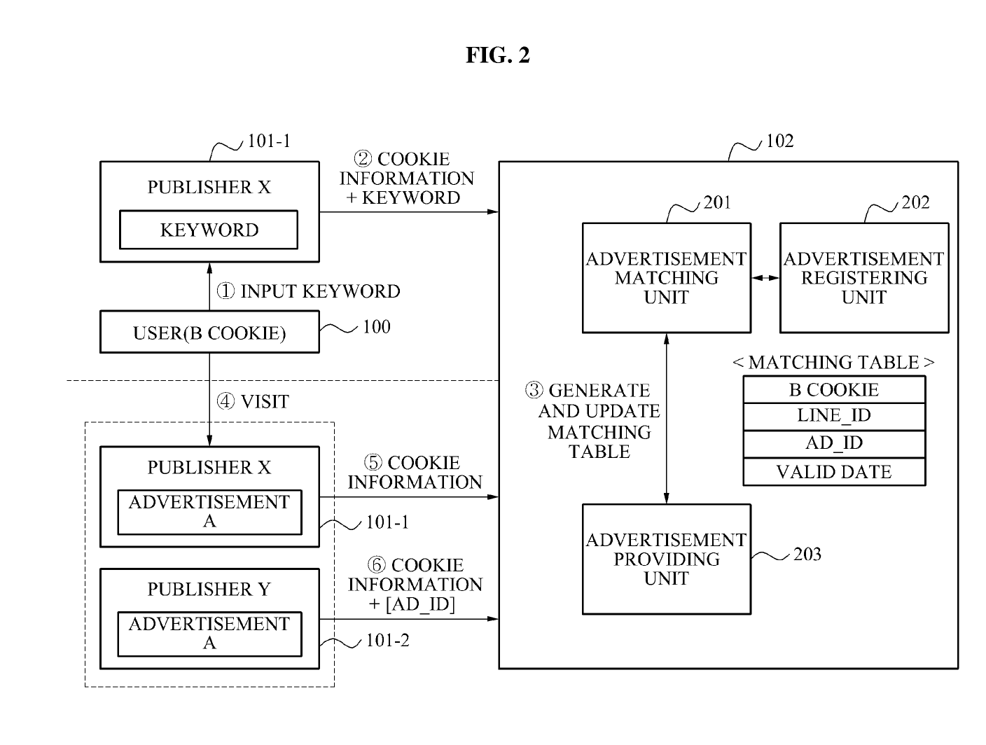

FIG. 2 is a diagram illustrating a structure of the system 102 for exposing an advertisement based on a keyword in real time according to exemplary embodiments of the present invention.

Referring to FIG. 2, the system 102 for exposing an advertisement, based on a keyword in real time, may include an advertisement matching unit 201, an advertisement registering unit 202, and an advertisement providing unit 203.

The user 100 may make a search by inputting a keyword in a publisher X 101-1. In this example, the publisher X 101-1 may be a search engine to provide a search result related to the keyword inputted by the user 100. The keyword inputted by the user 100 may be transmitted to the system 102 together with identity information of the user 100. In this example, the identity information of the user and the keyword may be transmitted based on a push scheme.

Also, the identity information of the user 100 may include cookie information of the user 100. The cookie information may be dependent on a terminal used by the user 100. Also, the identity information of the user 100 may include a login ID of the user 100. The login ID may be dependent on the user 100 using the same terminal. In FIG. 2, description is made based on cookie information.

The advertisement matching unit 201 may process the keyword inputted by the user 100, through the publisher X 101-1, to extract an advertisement matched to the keyword from the advertisement registering unit 202. Also, the advertisement matching unit 201 may generate a matching table, including the extracted advertisement and the keyword, based on the identity information of the user 100. The advertisement matching unit 201 may correspond to a query pre-processing server.

The advertisement matching unit 201 may request a matching condition related to the keyword to the advertisement registering unit 202. The advertisement registering unit 202 may search an advertisement already registered by an advertiser for a keyword, and may transmit the matching condition to the advertisement matching unit 201. For example, the advertisement registering unit 202 may transmit the matching condition based on a valid date, including the keywords, LINE_ID, and AD_ID. In this example, LINE_ID is a line ID where a matched keyword exists. Further, AD_ID is an advertisement ID where a matched keyword exists. The valid date may be set as 7 days from a keyword input date and may vary depending on a system configuration.

When an advertisement matched to the keyword exists, the advertisement matching unit 201 may generate a matching table corresponding to the identity information of the user 100. As seen in FIG. 2, the matching table may include cookie information as identity information of the user 100, LINE_ID as a line ID where a matched keyword exists, AD_ID as an advertisement ID where a matched keyword exists, or a valid date, that is, a predetermined elapsed time from a keyword input time.

Hereinabove, for a purpose of illustration, a process for generating a matching table corresponding to identity information of the user 100 was described, and a process for exposing an advertisement when the user 100 visits service pages of the publishers 101-1 and 101-2 will be described below.

The user 100 may visit the service page of the publisher X 101-1. The publisher X 101-1 may extract identity information of the user 100 and may transmit the identity information of the user 100 to the advertisement providing unit 203. In this example, the identity information of the user 100 may be cookie information, and may be extracted from a terminal of the user 100 connected to a system of the publisher X 101-1.

The advertisement providing unit 203 may determine whether an updated matching table exists in the advertisement matching unit 201 through the identity information of the user 100. When a matching table corresponding to the identity information exists, the advertisement providing unit 203 may identify an advertisement corresponding to the identity information of the user 100 in the matching table, and may transmit the advertisement to the publisher X 101-1.

When a plurality of advertisements, corresponding to the identity information of the user 100, exist in the matching table, the advertisement providing unit 203 may provide the publisher X 101-1 with an advertisement matched to a keyword inputted the most recently from the time when the user 100 visited the service page of the publisher X 101-1 among keywords inputted by the user 100 in the publisher X 101-1. It is contemplated that a relatively recently inputted keyword may reflect a subject of interest of the user 100 better so that an advertising effect may be improved.

In FIG. 2, when the user 100 visits the service page of the publisher Y 101-2 where the user did not input a keyword, cookie information as identity information of the user 100 may be transmitted to the advertisement providing unit 203. The same advertisement as the advertisement exposed through the service page of the publisher X 101-1 may be exposed to the user 100 through the service page of the publisher Y 101-2. For example, assuming that the user 100 inputs a keyword only in the publisher X 101-1, when the publisher X 101-1 is a search engine and the publisher Y 101-2 is a product purchasing site, an advertisement matched to the keyword inputted by the keyword may be exposed through the publisher Y 101-2 when the user 100 visits the product purchasing site.

The advertisement registering unit 202 may sell an advertiser an advertisement based on a keyword. Specifically, the advertisement registering unit 202 may determine the number of inventories for each keyword, using a search log, based on a keyword inputted by the user 100.

The advertisement registering unit 202 may collect the search log through the following process. The user 100 may conduct a search by inputting a keyword in a search window of the publisher X 101-1. In this example, the advertisement registering unit 202 may record the keyword inputted by the user 100 in cookie information that is, identity information of the user 100. For example, the advertisement registering unit 202 may record a keyword inputted for a predetermined time, set by the user 100, in cookie information to update the cookie information.

In this example, when the keyword inputted by the user 100 is a target keyword that is a keyword for selling to an advertisement, the advertisement registering unit 202 may record the keyword inputted by the user 200 in cookie information to update the cookie information.

For example, the advertisement registering unit 202 may calculate the number of marketable inventories for each target keyword. The advertisement registering unit 202 may determine the number of marketable inventories for each target keyword through the following process. In this example, the marketable inventory for each target keyword may be information provided when an advertiser purchases a target keyword, and may represent an estimated impression in an advertisement exposure area of the service page of the publisher Y 101-2. According to exemplary embodiments of the present invention, because an advertiser is informed prior to a selection of the number of inventories for a target keyword by the advertiser, based on a guarantee purchased by the advertiser, the advertiser may recognize an advertising effect for the keyword.

Specifically, the advertisement registering unit 202 may provide an estimated impression, for each inventory, based on a guarantee purchased by an advertiser. For example, the inventory may represent a content or a location of a service when an advertisement of the advertiser is exposed on the service page of the publisher X 101-1, after the user 100 inputs a keyword. The advertiser may be guaranteed an opportunity for advertisement exposure through the inventory by purchasing a guarantee. When the guarantee is expended during an advertising campaign or when an advertising campaign is terminated, the advertisement of the advertiser may not be exposed through the inventory.

According to exemplary embodiments of the present invention, the advertisement registering unit 202 may determine an inventory for each target keyword, using a keyword share of a target keyword to be sold to an advertiser, among all keywords inputted by a plurality of users in a search window. A process for determining an inventory for each target keyword is described below in more detail with reference to FIG. 2.

According to exemplary embodiments of the present invention, communication with an advertiser about CPM-based advertisement purchasing may be improved by determining an inventory for each marketable target keyword. Also, quality of an advertisement may be enhanced by updating information for advertisement purchasing, and an advertiser may execute a targeted advertisement.

For example, the inventory determining unit 201 may determine an inventory, corresponding to a target keyword, based on a keyword share of the target keyword to all keywords and the number of inventories for each advertisement unit. In this instance, the inventory of the target keyword may be determined by the following Equation 1.

Inventory for each target keyword=keyword share×number of inventories for each advertisement unit [Equation 1]

Also, for example, the inventory determining unit 201 may determine an inventory, corresponding to a target keyword, based on a keyword share of the target keyword to all keywords, the number of inventories for each advertisement unit, and a recency coefficient based on the number of target keywords stored in a search log. By way of example, when matching with 10 keywords recently inputted by a user is considered, not matching with one keyword recently inputted by the user, the number of marketable target keywords may approximately increase 10 times. An increment of the marketable target keyword may be reflected on the recency coefficient. In this example, the inventory of the target keyword may be determined by the following Equation 2.

Inventory for each target keyword=keyword share×number of inventories for each advertisement unit×recency coefficient [Equation 2]

For example, it is assumed that keywords stored in a cookie of the user are shown in Table 1. In this example, it is assumed that target keywords are A, C, E, and I. In Table 1, the row is a query count (QC), and the column is a user.

TABLE 1

| | 1st | 2nd | 3rd | 4th | 5th | 6th | 7th | 8th | 9th | 10th |
|---|---|---|---|---|---|---|---|---|---|---|
| a | A | B | C | D | E | F | G | H | I | J |
| b | B | C | D | E | F | G | H | I | J | K |
| c | C | D | E | F | G | H | I | J | K | L |
| d | D | E | F | G | H | I | J | K | L | M |
| e | E | F | G | H | I | J | K | L | M | N |
| f | F | G | H | I | J | K | L | M | N | O |
| g | G | H | I | J | K | L | M | N | O | P |
| h | H | I | J | K | L | M | N | O | P | Q |
| i | I | J | K | L | M | N | O | P | Q | R |
| j | J | K | L | M | N | O | P | Q | R | S |

In Table 1, a marketable inventory is 4, to determine an inventory for recent one target keyword. However, a marketable inventory can be increased to 18 to determine an inventory for 10 recent target keywords.

That is, a varying ratio of the number of inventories, depending on recency relative to an inventory determining time, may represent a recency coefficient. However, the recency coefficient may vary depending on a ratio of a QC of a target keyword to a QC of all keywords. Specifically, when the ratio of the QC of the target keyword is high, the recency coefficient may be determined to be low because an inventory increasing extent is not great, although, a recency range is extended. Conversely, when the ratio of the QC of the target keyword is low, the recency coefficient may be determined to be high because an inventory increasing extent is great when a recency range is extended.

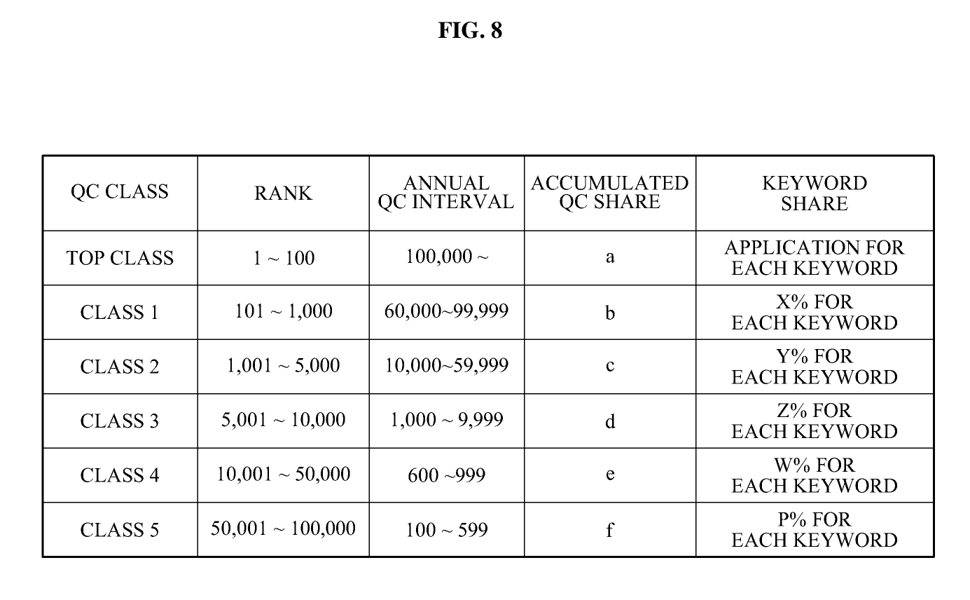

Also, the advertisement registering unit 202 may determine an inventory corresponding to a target keyword based on a class corresponding to a QC of a target keyword. Specifically, a higher QC of a target keyword may be determined as a higher class, and a target keyword, determined as a higher class, may be determined to have a higher keyword share. The class of the target keyword is described below in more detail with reference to FIG. 8.

For example, the advertisement registering unit 202 may receive, from an advertiser, a selection of an advertisement unit that is, an advertisement area exposed on a service page designed to expose an advertisement. In this example, the advertisement area exposed on the service page may be at least one.

After the advertiser selects the advertisement unit, the advertiser may select a target keyword. Then, the advertisement registering unit 202 may register an advertisement corresponding to an amount of usable inventories by checking into an inventory which is further corresponding to the target keyword selected by the advertiser. In this example, the advertiser may also input advertisement information related to advertisement exposure.

For example, the advertiser may also input user information on which an advertisement of the advertiser will be based. In this example, the user information may include, foe example, an age, a gender, a search time zone, a search region of the user.

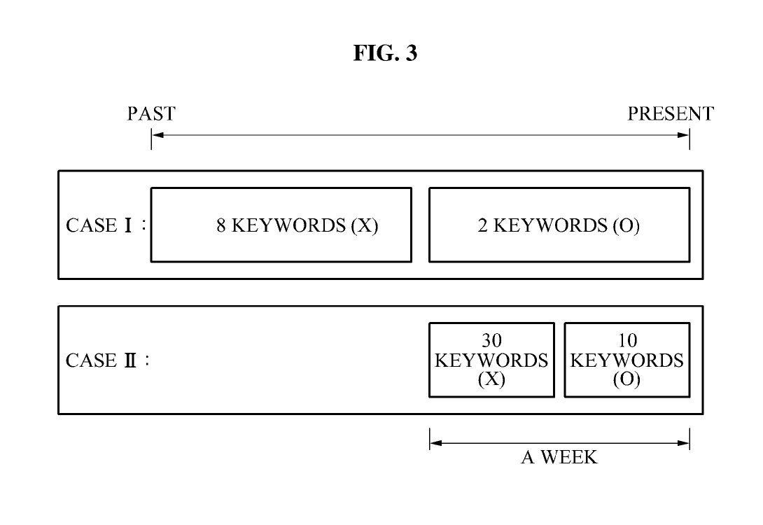

FIG. 3 is a diagram illustrating an example of a keyword to determine a subject of interest of a user according to exemplary embodiments of the present invention.

Referring to FIG. 3, a method for determining an effective reference time to determine a subject of interest of a user is described. To determine a subject of interest of a user, a condition about the number of keywords recently inputted and how many days per the keywords were recently inputted may be required.

CASE I shows an effective reference time to determine a subject of interest of a user. For example, referring to CASE 1, although the user inputted 10 keywords for search, when the number of keywords inputted recently within a week is 2, it may be determined that the 8 keywords inputted before the week does not reflect the subject of interest of the user.

CASE II shows an effective keyword number to determine a subject of interest of a user. For example, referring to CASE II, although the user inputted 40 keywords for a week, it may be determined that only the recently inputted 10 keywords reflect the subject of interest of the user.

According to exemplary embodiments of the present invention, when an advertisement is exposed while reflecting a subject of interest of a user, an effective reference time and an effective keyword number configured to determine the subject of interest of the user may be set. The exposed advertisement may be matched to the subject of interest of the user. Accordingly, an interest degree of the user in the advertisement may be improved.

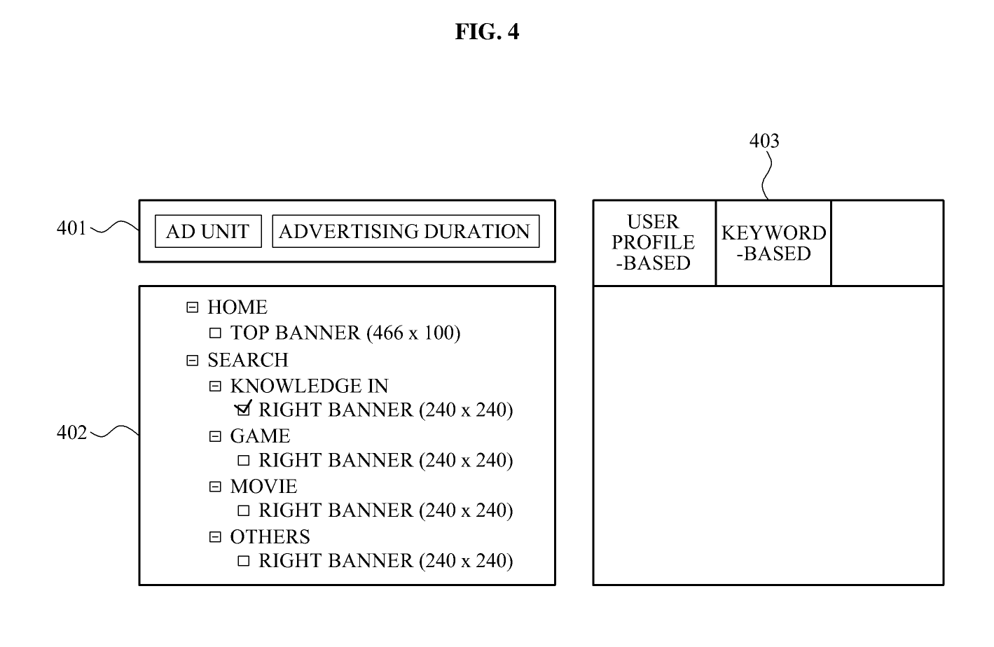

FIG. 4 is a diagram illustrating an example of an advertisement unit set by an advertiser according to exemplary embodiments of the present invention.

The user may set an advertising duration for which an advertisement is exposed in an advertisement unit through an interface 401. For example, an advertisement registered by an advertiser may firstly be exposed during an advertising duration, and after conclusion of the advertising duration, an advertisement registered by another advertiser may be exposed.

For an advertiser to register an advertisement, the advertiser may set an advertisement unit through the interface 402. In this example, when a user visits a service page through a keyword, the advertisement unit may be a kind of the service page and a location where an advertisement is exposed on the service page.

For example, the advertiser may set a target keyword, on which the advertisement will be based, by selecting a keyword-based tab 403.

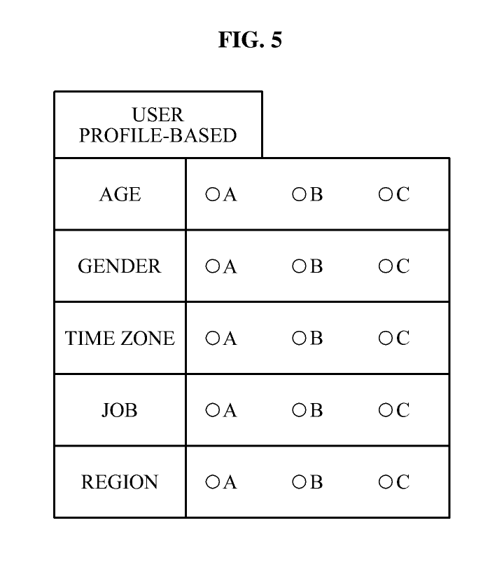

FIG. 5 is a diagram illustrating an example of user profile setting according to exemplary embodiments of the present invention.

FIG. 5 illustrates a case where an advertiser selects a user profile-based tab in FIG. 4. The advertiser may enable an advertisement of the advertiser to be exposed when the advertisement is matched to a subject of interest of a user by selecting user information such as an age, a gender, a time zone, a job, a region of the user. Although FIG. 5 shows an example of a user profile set by an advertiser, the user profile may be substantially set through a search pattern of a user or may be extracted from information directly inputted by the user by way of configurations.

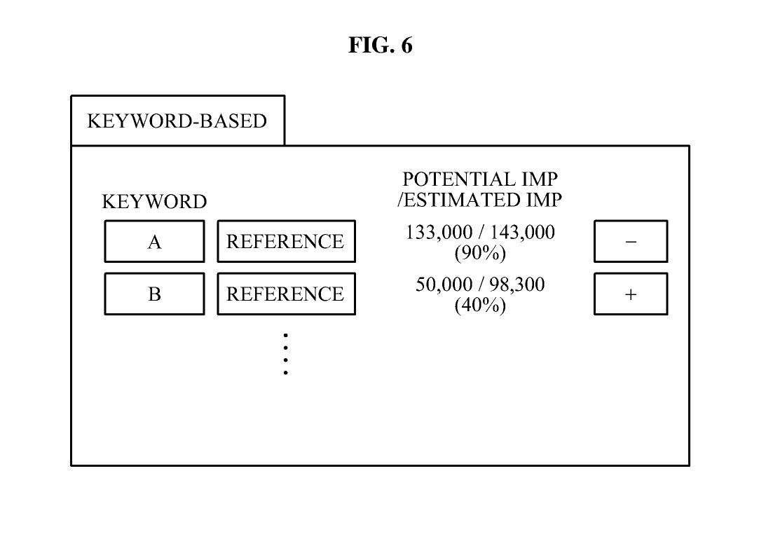

FIG. 6 is a diagram illustrating an example of impressions provided for an inventory of a keyword according to exemplary embodiments of the present invention.

FIG. 6 illustrates an example where an advertiser selects a keyword-based tab in FIG. 4. The advertiser may set a target keyword, on which an advertisement of the advertiser will be exposed based, by selecting a keyword-based tab. When a keyword inputted by the user corresponds to the target keyword, the advertisement of the advertiser may be exposed through an advertisement unit.

In this example, the advertiser may select at least one target keyword. Also, the advertiser may delete a target keyword after the advertiser selects the target keyword. The system, according to the exemplary embodiments of the present invention, may provide a potential IMP (Impression) and an estimated IMP of a selected target keyword. Here, the estimated IMP may represent the entire inventory of a target keyword based on an advertising duration and an advertisement unit set by an advertiser, and the potential IMP may represent a marketable inventory of a target keyword based on an advertising duration and an advertisement unit set by an advertiser.

As described above, the inventory described in the exemplary embodiments of the present invention may represent a potential impression, when an advertisement of an advertiser is exposed after a user inputs a keyword. The advertiser may secure an inventory by purchasing a guarantee.

Referring to FIG. 6, a potential IMP of a target keyword A is 133,000 and an estimated IMP is 143,000 based on an advertisement unit and an advertising duration. In this example, this means that 10% of the target keyword A was sold to another advertiser. This may vary depending on an advertisement unit and an advertising duration. The advertiser may secure an inventory of 133,300 maximum for the target keyword A by purchasing a guarantee.

Also, a potential IMP of a target keyword B is 50,000 and an estimated IMP is 98,300, based on an advertisement unit and an advertising duration. In this example, this means that 60% of the target keyword B was sold to another advertiser. The advertiser may secure an inventory of 50,000 maximum for the target keyword B by purchasing a guarantee.

Referring to FIG. 6, because an advertiser is provided with a potential IMP and an estimated IMP for each target keyword, the advertiser may refer to the potential IMP and the estimated IMP when the advertiser registers an advertisement for a target keyword. Also, the advertiser may indirectly recognize which target keyword is popular.

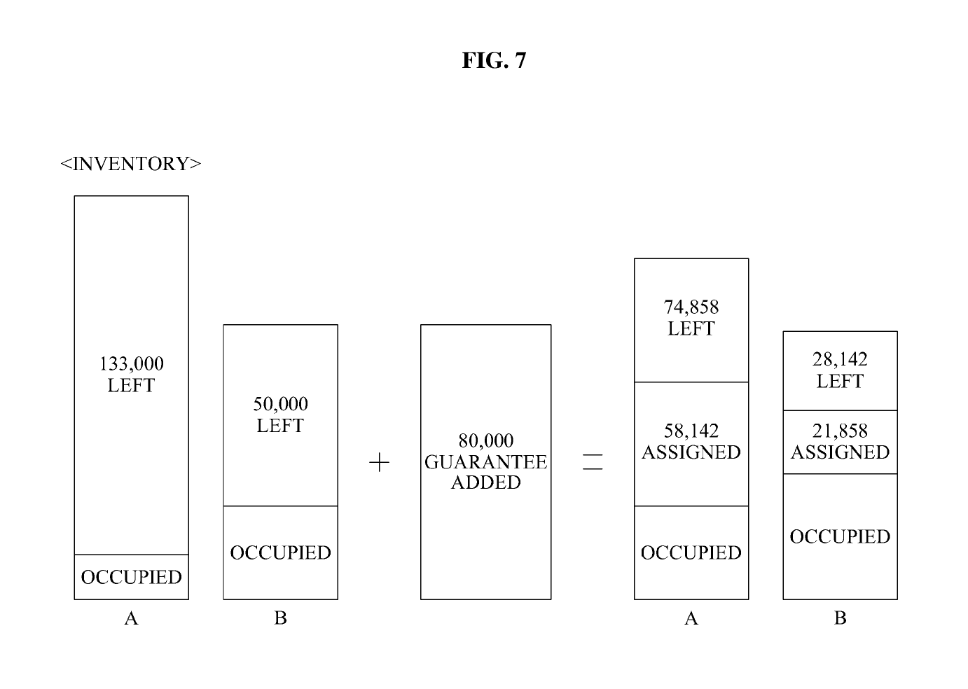

FIG. 7 is a diagram illustrating an example of guarantees added to a plurality of keywords according to exemplary embodiments of the present invention.

FIG. 7 illustrates an exemplary embodiment where an advertiser selects a target keyword A and a target keyword B and purchases a guarantee of 80,000 in FIG. 6. All of the guarantee of 80,000 may be added to an inventory of the target keyword A or an inventory of the target keyword B.

Also, according to exemplary embodiments of the present invention, the guarantee may be assigned based on the remnant inventory. For example, a guarantee assigned to the target keyword A may be 80000×(133000/(133000+50000))=58,142, and a guarantee assigned to the target keyword B may be 80000×(50000/(133000+50000))=21,858. An advertisement of an advertiser may be exposed as much as 58,142 for the target keyword A, and may be exposed as much as 21,858 for the target keyword B.

Also, another advertiser may use an inventory as much as 74,858 in relation to the target keyword A and may use an inventory as much as 28,142 in relation to the target keyword B based on the same advertisement unit and the same advertising duration.

FIG. 8 is a diagram illustrating an example of a keyword share, sorted for each class of a target keyword, according to exemplary embodiments of the present invention.

Referring to FIG. 8, a class may be determined based on a QC of a target keyword. Also, the class may be determined based on an annual QC.

When a QC of the target keyword X in March is 10,000, an annual QC of the target keyword X is 10,000×12=120,000 and a class of the target keyword X is top class. In this example, a keyword share of the keyword X may be separately calculated. For example, a keyword share of a target keyword in a top class may be calculated by (QC in March/(total daily QC×30)). In this example, an estimated inventory may be obtained by applying a keyword share of the target keyword X to the Equation 1 or 2. Also, the inventory may vary depending on an advertisement unit.

However, when a QC of the target keyword Y in March is 5,000, an annual QC of the target keyword Y is 5,000×12=60,000 and a class of the target keyword Y is class 1. In this example, a keyword share of the target keyword Y may be determined as Y %. In this example, an estimated inventory may be obtained by applying a keyword share, of the target keyword Y, to either the Equation 1 or 2.

According to the present invention, a keyword share for each class may vary depending on a target keyword having a high QC and a target keyword having a low QC, thereby reducing a management cost.

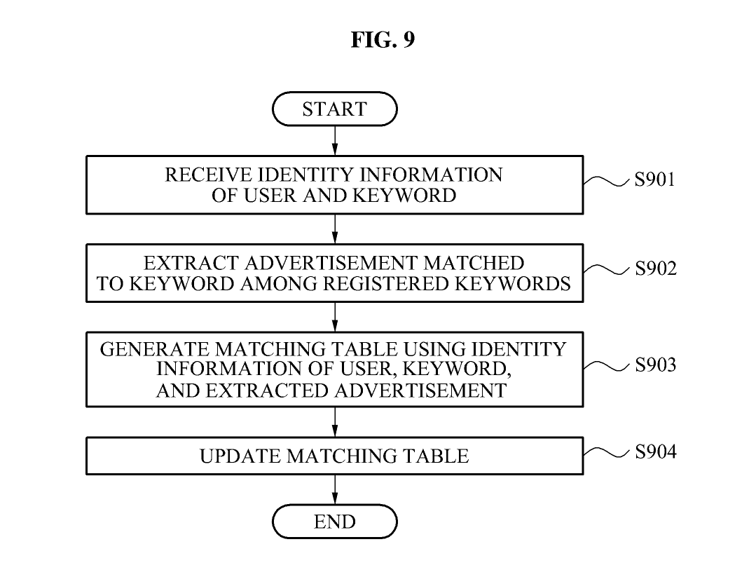

FIG. 9 is a flowchart illustrating a process for generating a matching table according to exemplary embodiments of the present invention.

In step 901, the system 102 for exposing an advertisement based on a keyword in real time may receive identity information of a user and a keyword form a publisher. In this example, the identity information of the user may be checked through a terminal of the user connected to a system of the publisher. Also, the keyword may be inputted in the publisher by the user for search. In this example, the identity information may be cookie information of the user.

In step 902, the system 102 may extract an advertisement matched to the keyword among advertisements of an advertiser. In this example, the advertiser may register an advertisement after the advertiser is provided with an estimated impression for each inventory provided by the system 102. For example, the advertiser may check an objective advertising effect on an inventory set by the advertiser.

In step 903, the system 102 may generate a matching table using the identity information of the user, the keyword, and the extracted advertisement. In this example, the system 102 may generate a matching table if an advertisement matched to the keyword inputted by the user exists.

In step 904, the system 102 may update the matching table by extracting an advertisement, based on a keyword, whenever the user inputs the keyword.

Also, the system 102 may store search history information for each user, and when a request for an advertisement is received, the system 102 may identify advertisement information corresponding to a search history of the advertisement. In this example, a separate matching table may not be maintained, however, a response rate may be reduced as opposed to an example where a matching table based on real-time processing is used.

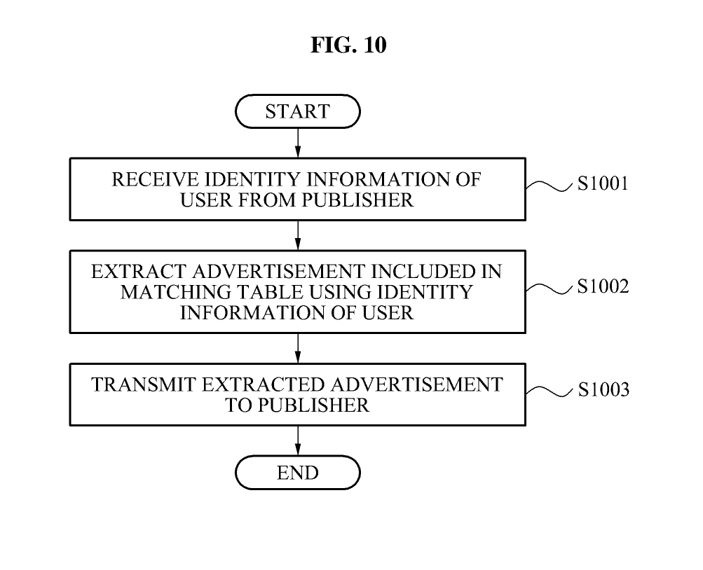

FIG. 10 is a flowchart illustrating a process for providing an advertisement based on identity information of a user according to exemplary embodiments of the present invention.

In step 1001, when a user visits a service page of a publisher, the system 102 for exposing an advertisement based on a keyword in real time may receive identity information of the user from the publisher.

In step 1002, the system 102 may extract an advertisement included in a matching table using the identity information of the user. For example, the identity information of the user may be sufficient to expose an advertisement through the service page of the publisher. For example, the system 102 may extract, from the matching table, an advertisement matched to a keyword inputted the most recently from the time of visiting the service page of the publisher among keywords inputted by the user.

In step 1003, the system 102 may transmit the extracted advertisement to the publisher. In this example, the publisher may expose the advertisement through the service page so that the user may recognize the advertisement.

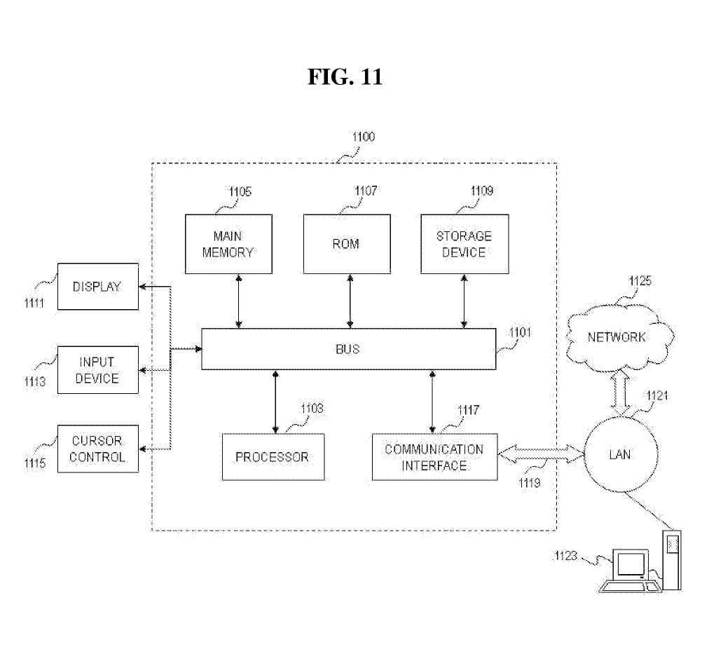

FIG. 11 illustrates computing hardware (e.g., computer system) 1100 upon which an embodiment according to the invention can be implemented. The computer system 1100 includes a bus 1101 or other communication mechanism for communicating information and a processor 1103 coupled to the bus 1101 for processing information. The computer system 1100 also includes main memory 1105, such as a random access memory (RAM) or other dynamic storage device, coupled to the bus 1101 for storing information and instructions to be executed by the processor 1103. Main memory 1105 can also be used for storing temporary variables or other intermediate information during execution of instructions by the processor 1103. The computer system 1100 may further include a read only memory (ROM) 1107 or other static storage device coupled to the bus 1101 for storing static information and instructions for the processor 1103. A storage device 1109, such as a magnetic disk or optical disk, is coupled to the bus 1101 for persistently storing information and instructions.

The computer system 1100 may be coupled via the bus 1101 to a display 1111, such as a cathode ray tube (CRT), liquid crystal display, active matrix display, or plasma display, for displaying information to a computer user. An input device 1113, such as a keyboard including alphanumeric and other keys, is coupled to the bus 1101 for communicating information and command selections to the processor 1103. Another type of user input device is a cursor control 1115, such as a mouse, a trackball, or cursor direction keys, for communicating direction information and command selections to the processor 1103 and for controlling cursor movement on the display 1111.

According to an embodiment of the invention, the processes described herein are performed by the computer system 1100, in response to the processor 1103 executing an arrangement of instructions contained in main memory 1105. Such instructions can be read into main memory 1105 from another computer-readable medium, such as the storage device 1109. Execution of the arrangement of instructions contained in main memory 1105 causes the processor 1103 to perform the process steps described herein. One or more processors in a multi-processing arrangement may also be employed to execute the instructions contained in main memory 1105. In alternative embodiments, hard-wired circuitry may be used in place of or in combination with software instructions to implement the embodiment of the invention. Thus, embodiments of the invention are not limited to any specific combination of hardware circuitry and software.

The computer system 1100 also includes a communication interface 1117 coupled to bus 1101. The communication interface 1117 provides a two-way data communication coupling to a network link 1119 connected to a local network 1121. For example, the communication interface 1117 may be a digital subscriber line (DSL) card or modem, an integrated services digital network (ISDN) card, a cable modem, a telephone modem, or any other communication interface to provide a data communication connection to a corresponding type of communication line. As another example, communication interface 1117 may be a local area network (LAN) card (e.g. for Ethernet™ or an Asynchronous Transfer Model (ATM) network) to provide a data communication connection to a compatible LAN. Wireless links can also be implemented. In any such implementation, communication interface 1117 sends and receives electrical, electromagnetic, or optical signals that carry digital data streams representing various types of information. Further, the communication interface 1117 can include peripheral interface devices, such as a Universal Serial Bus (USB) interface, a PCMCIA (Personal Computer Memory Card International Association) interface, etc. Although a single communication interface 1117 is depicted in FIG. 11, multiple communication interfaces can also be employed.

The network link 1119 typically provides data communication through one or more networks to other data devices. For example, the network link 1119 may provide a connection through local network 1121 to a host computer 1123, which has connectivity to a network 1125 (e.g. a wide area network (WAN) or the global packet data communication network now commonly referred to as the “Internet”) or to data equipment operated by a service provider. The local network 821 and the network 1125 both use electrical, electromagnetic, or optical signals to convey information and instructions. The signals through the various networks and the signals on the network link 1119 and through the communication interface 1117, which communicate digital data with the computer system 1100, are exemplary forms of carrier waves bearing the information and instructions.

The computer system 1100 can send messages and receive data, including program code, through the network(s), the network link 1119, and the communication interface 1117. In the Internet example, a server (not shown) might transmit requested code belonging to an application program for implementing an embodiment of the invention through the network 1125, the local network 1121 and the communication interface 1117. The processor 803 may execute the transmitted code while being received and/or store the code in the storage device 1109, or other non-volatile storage for later execution. In this manner, the computer system 800 may obtain application code in the form of a carrier wave.

The term “computer-readable medium” as used herein refers to any medium that participates in providing instructions to the processor 1103 for execution. Such a medium may take many forms, including but not limited to non-volatile media, volatile media, and transmission media. Non-volatile media include, for example, optical or magnetic disks, such as the storage device 1109. Volatile media include dynamic memory, such as main memory 1105. Transmission media include coaxial cables, copper wire and fiber optics, including the wires that comprise the bus 1101. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

According to embodiments of the present invention, an advertising effect may be maximized by extracting a subject of interest of a user based on a keyword inputted by the user and by providing an advertisement related to the subject of interest of the user.

According to embodiments of the present invention, an advertisement matched to a most recently inputted keyword, among keywords inputted by a user, may be provided, thereby precisely reflecting a subject of interest of the user at the time of visiting a service page of a publisher.

According to embodiments of the present invention, an advertiser may be provided with objective information related to subjects of interest of users, by determining information about a marketable advertisement inventory, to register an advertisement using search logs based on search activities of the users.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A system for providing an advertisement based on a keyword, the system comprising:
an inventory determining unit configured to determine an inventory for a target keyword associated with providing an advertisement, the determination is performed by using a search log based on a keyword of a user; and
an advertisement registering unit to register the advertisement into the inventory corresponding to the target keyword selected by an advertiser.

2. The system of claim 1, wherein the inventory determining unit is configured to collect a search log by storing a keyword corresponding to the user in a cookie in response to detection of a search request associated with the keyword.

3. The system of claim 1, wherein the inventory determining unit is configured to determine an inventory of the target keyword for an advertisement to be exposed with respect to the advertisement areas of a service page if the keyword is determined the target keyword.

4. The system of claim 3, wherein the inventory determining unit is configured to determine an inventory corresponding to the target keyword based on a keyword share of the target keyword, a number of inventories for the respective advertisement areas, or both the keyword share of the target keyword and the number of inventories for the respective advertisement areas.

5. The system of claim 3, wherein the inventory determining unit is configured to determine the inventory corresponding to the target keyword based on a keyword share of the target keyword, the number of inventories for the respective advertisement areas, a recency coefficient based on a number of target keywords stored in the search log, or any combination thereof.

6. The system of claim 4, wherein the inventory determining unit is configured to determine the inventory corresponding to the target keyword based on a class corresponding to a query count of the target keyword.

7. The system of claim 1, further comprising:
an advertisement exposing unit configured to expose the registered advertisement for the target keyword based on whether the keyword of the user corresponds to the target keyword.

8. The system of claim 1, further comprising:
an advertisement charging unit configured to charge for the advertisement if the advertisement for the keyword is exposed.

9. A method for exposing an advertisement based on a keyword, the method comprising:
determining an inventory for a target keyword using a search log based on a keyword of a user, wherein the inventory comprises a marketable advertisement corresponding to the target keyword and the marketable advertisement is registered into the inventory if selected by an advertiser.

10. The method of claim 9, wherein the determining an inventory for a target keyword comprises collecting a search log by storing a keyword corresponding to the user in a cookie in response to detection of a search request associated with the keyword.

11. The method of claim 9, wherein the determining an inventory for a target keyword comprises determining an inventory of a target keyword for an advertisement to be exposed with respect to the advertisement areas of a service page if the keyword is the target keyword.

12. The method of claim 11, wherein the determining an inventory for a target keyword comprises determining an inventory corresponding to the target keyword based on a keyword share of the target keyword, the number of inventories for the respective advertisement areas, or any combination thereof.

13. The method of claim 11, wherein the determining an inventory for a target keyword comprises determining an inventory corresponding to the target keyword based on a keyword share of the target keyword, a number of inventories for the respective advertisement areas, a recency coefficient based on the number of target keywords stored in the search log, or any combination thereof.

14. The method of claim 12, wherein the determining an inventory for a target keyword comprises determining an inventory corresponding to the target keyword based on a class corresponding to a query count of the target keyword.

15. The method of claim 9, further comprising:
exposing the registered advertisement for the target keyword based on whether the keyword corresponds to the target keyword.

16. The method of claim 9, further comprising:
charging for the advertisement if the advertisement for the keyword is exposed.

17. A non-transitory computer-readable storage medium comprising an executable program, which when executed, performs the step of claim 9.

18. A system for exposing an advertisement based on a keyword, the system comprising:
an advertisement matching unit configured to extract an advertisement matched to a keyword to generate a matching table;
an advertisement registering unit configured to receive registration of an advertisement from an advertiser; and
an advertisement providing unit configured to extract the advertisement from the matching table based on identity information associated with the user and to provide the extracted advertisement.
